(19) United States
(12) Patent Application Publication
(10) Pub. No.: US 2009/0257721 A1
(43) Pub. Date: Oct. 15, 2009

(54) Optical Transmission Element Having High Temperature Stability

(76) Inventors: Dieter Kundis, Lautertal (DE); Gunter Wunsch, Neustadt bei Coburg (DE); Gerhard Merbach, Neustadt bei Coburg (DE)

Correspondence Address: CORNING INCORPORATED, INTELLECTUAL PROPERTY DEPARTMENT, SP-TI-3-1, CORNING, NY, 14831, US

(21) Appl. No.: 12/485,273

(22) Filed: Jun. 16, 2009

Related U.S. Application Data
(63) Continuation of application No. PCT/EP07/63730, filed on Dec. 11, 2007.

(30) Foreign Application Priority Data
Dec. 20, 2006 (DE) 102006060431.8

(51) Int. Cl. G02B 6/44

(52) U.S. Cl. 385/109

(57) ABSTRACT

An optical transmission element has a number of optical waveguides, which are arranged as a bundle and are embedded in a filling composition. The optical waveguides and the filling composition are surrounded by a tube. A material comprising a resin, which for example contains an acrylate enriched with a filler, is used as materials for the tube. By mixing photoinitiators into the material comprising the resin of the tube, the tube material of the tube can be cured by irradiation with ultraviolet light. The use of a material comprising resin in the production of the tube of the optical transmission element allows thin buffering layers to be produced at a high material processing speed.

### CROSS-REFERENCE TO RELATED APPLICATIONS

This application is a continuation of International Application No. PCT/EP07/063730, filed Dec. 11, 2007, the entire contents of which are hereby incorporated by reference.

### TECHNICAL FIELD

The disclosure relates to an optical transmission element having high temperature stability, in which at least one optical waveguide is arranged in a buffer tube. The disclosure also relates to an optical cable with an optical transmission element in which at least one optical waveguide is arranged in a buffer tube. The disclosure also relates to a method for producing such an optical transmission element and to a method for producing such an optical cable.

### BACKGROUND

In the case of an embodiment of an optical cable, so-called micromodules as optical transmission elements are surrounded by a cable jacket. A micromodule contains a number of optical waveguides which are surrounded by a thin buffer tube. The purpose of the micromodules is the bundling of a number of optical waveguides and their identification by color. At present, the buffer tube of a micromodule consists of polymer blends that are extruded as a thin buffering layer around the optical waveguides in extrusion installations for thin-layer extrusion.

In the extrusion installations, the polymer blends are melted. In the extrusion operation, the molten polymer blend is forced through dies and extruded as a buffer tube around the optical waveguides and the filling composition. Polymers are long-chain molecules, which are particularly difficult to process when thin layers, for example buffer tubes, are being produced. The thin-layer extrusion of polymer materials at high speeds is technically challenging in particular. At present, increasing the processing speed of the molten polymer during the extrusion operation and reducing the layer thicknesses of the tube of a micromodule presents a technical problem. Further difficulties arise from the fact that polymer materials can only be used in low temperature ranges. The low-melting polymer materials that are currently used have a melting temperature of between 70° C. and 80° C.

### SUMMARY

An optical transmission element which is produced using materials that can be easily processed and allow a wide range of applications is to be specified hereinafter. It is also desirable to specify an optical cable which contains optical transmission elements that can be easily processed and can be used in a broad range of applications. There is also a need to specify a method for producing an optical transmission element in which materials that can be easily processed and make a wide range of applications of the optical transmission element possible are used. A method for producing an optical cable using optical transmission elements which contain materials that can be easily processed and allow the optical cable to be used in a wide range of applications is also to be specified.

According to a possible embodiment of the optical transmission element, the optical transmission element comprises at least one optical waveguide which contains a glass fiber. Furthermore, the optical transmission element comprises a tube, which surrounds a space in which the at least one optical waveguide is contained. The tube is formed from a material which comprises a resin.

Previously, polymer blends have been used for producing such tubes, for example buffer tubes, of optical transmission elements. The enclosing of the individual optical waveguides took place on extrusion installations for thin-layer extrusion. The thin-layer extrusion of polymers at high speeds presents a technical problem in particular. Furthermore, for an optical transmission element, the buffer tube should be easily removed. For this purpose it is necessary, for example, for the layer thickness of the buffer tube to be reduced. With the use of polymer blends as the material for the buffer tubes, at present it appears to be no longer possible to the greatest extent to obtain both further increases in speed and a reduction in the layer thicknesses for technical reasons. Furthermore, the polymer systems that are currently used only allow restricted temperature ranges. For instance, in the case of an optical transmission element in which a polymer blend is used as the material for its buffer tube, an operating temperature of 70° C. to 80° C. should not be exceeded.

Several advantages are achieved by the use of resin systems instead of thermoplastic polymers. For example, higher processing speeds can be achieved. Furthermore, optical transmission elements having buffer tubes formed from a resin material have a higher temperature stability. The resin system is chemically devised in such a way that easy removal of the tube is possible by adjusting the oligomers and/or fillers of the resin, for example of an acrylic resin.

The material comprising the resin of the tube may contain an acrylate. A filler may also be mixed into the material comprising the resin of the tube. For example, inorganic materials may be mixed as fillers into the resin. Furthermore, glass fiber offcuts, chalk or magnesium hydroxide may be mixed as a filler into the material comprising the resin of the tube.

When the material is irradiated with light, a network structure may form in the material comprising the resin of the tube. The material comprising the resin of the tube may, for example, contain photoinitiators, a network structure forming in the material comprising the resin of the tube when the photoinitiators are irradiated with ultraviolet light.

The material comprising the resin of the tube may, for example, comprise molecules of methacrylic acid.

The at least one optical waveguide is, for example, movably arranged in the space surrounded by the tube. The space surrounded by the tube may also contain a filling composition. The filling composition may, for example, contain mineral or paraffin oils. It may also contain a material comprising rubber or aerosil.

The at least one optical waveguide may comprise a cladding which compactly surrounds at least one glass fiber. For example, the cladding which surrounds the at least one glass fiber may likewise be formed from the material comprising the resin.

An optical cable comprises at least one optical transmission element according to one of the aforementioned embodiments. Furthermore, the optical cable has a cable jacket which surrounds a space in which the at least one optical transmission element is contained.

The at least one optical transmission element is movably arranged in the space surrounded by the cable jacket. Furthermore, it may be provided that the space surrounded by the cable jacket contains a filling composition.

A method for producing an optical transmission element is specified hereinafter.

According to the method, it is provided that at least one optical waveguide which contains a glass fiber is provided. A space in which the at least one optical waveguide is contained is surrounded with a tube, the tube being formed from a material which comprises a resin.

A material which contains an acrylate may be used as the material comprising the resin. A material which contains molecules of methacrylic acid may be used as the acrylate. A material which contains inorganic fillers may also be used as the material comprising the resin. Glass fiber offcuts, chalk and/or magnesium hydroxide may be used, for example, as inorganic fillers.

Before the step of surrounding the at least one optical waveguide with the tube, the at least one optical waveguide is surrounded with a filling composition. The step of surrounding the at least one optical waveguide with the filling composition and the step of surrounding the filling composition with the tube may, for example, take place at the same time. The step of surrounding the at least one optical waveguide with the filling composition and the step of surrounding the filling composition with the tube may, for example, take place by the at least one optical waveguide being wetted with the filling composition and at the same time the filling composition being wetted with the material comprising the resin. For example, the filling composition and the resin system may be applied in one operation by means of double-layer wetting. The optical waveguides to be coated may in this case run through a single tooling system. Since only one tooling system is used, it is made easier for a machine plant to be started up and operated. The double-layer wetting also allows higher production speeds to be achieved and thinner buffering layers to be formed than is possible when the tube is produced with a heated polymer blend. For example, production speeds of between 500 and 700 m/min can be achieved and a thin buffering layer of between 0.05 mm and 0.5 mm can be produced by the use of resin systems.

According to the method, the material comprising the resin can be cured by irradiating with light after the step of wetting the at least one optical waveguide with the filling composition and the material comprising the resin.

According to a method for producing an optical cable, at least one optical transmission element is produced in accordance with one of the aforementioned embodiments. The at least one optical transmission element is surrounded with a cable jacket.

It is to be understood that both the foregoing general description and the following detailed description present exemplary embodiments of the invention, and are intended to provide an overview or framework for understanding the nature and character of the invention as it is claimed. The accompanying drawings are included to provide a further understanding of the invention, and are incorporated into and constitute a part of this specification. The drawings illustrate various embodiments of the invention, and together with the detailed description, serve to explain the principles and operations thereof

### BRIEF DESCRIPTION OF THE DRAWINGS

FIG. 1 shows an embodiment of an optical transmission element with a tube of a material that is easy to process and that can be used at high temperatures.

FIG. 2 shows an embodiment of an optical cable with optical transmission elements which contain materials that make easy processing and use of the cable at high temperatures possible.

FIG. 3 shows an embodiment of a production line for producing an optical transmission element which comprises materials that can be easily processed and make use of the optical transmission element at high temperatures possible.

FIG. 4 shows a further embodiment of a production line for producing an optical cable using optical transmission elements which contain materials that make easy processing and use of the optical cable at high temperatures possible.

### DETAILED DESCRIPTION

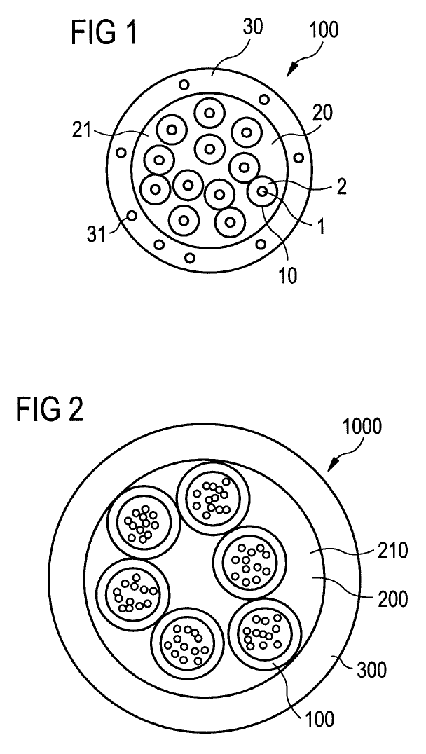

FIG. 1 shows an embodiment of an optical transmission element in which a number of optical waveguides 10 are arranged as a bundle and are surrounded by a tube 30. The optical waveguides 10 are, for example, formed as tight buffers, which contain a glass fiber 1 surrounded by a compact cladding 2. A filling composition 21 is contained in a space 20 that is surrounded by the tube 30. The filling composition 21 contains plastics of a gel-like formulation. They may, for example, comprise a mixture of mineral or paraffin oil, rubber and aerosils.

Instead of the previously customary polymer blends, the tube 30 of the optical transmission element contains a material comprising a resin. The tube 30 may, for example, contain acrylates. The acrylates used are preferably molecules of methacrylic acid. They contain monomers with a short chain length and oligomers with a longer chain length. The mechanical properties of the acrylic resin, such as for example hardness, elongation at break and deformability, can be adjusted by means of the proportion of oligomers in the acrylates. The higher the proportion of oligomers, the harder the resin, and consequently the harder the tube 30 of the optical transmission element.

Furthermore, fillers may be mixed into the material comprising the acrylates of the tube 30. Inorganic materials are substantially used. For example, chalk or magnesium hydroxides are used. Furthermore, it is possible additionally to embed glass fiber offcuts 31 in the acrylates. The resin system of the tube 30 is preferably formed as an acrylate system, which when irradiated with light, for example with ultraviolet light, forms a network-like structure and thereby cures. The same materials that are used for the tube 30 of the optical transmission element may also be used for the cladding 2, which compactly surrounds the glass fiber 1.

FIG. 2 shows an embodiment of an optical cable 1000 which contains a number of optical transmission elements corresponding to the micromodules 100 of FIG. 1. The micromodules 100 contain a number of optical waveguides 10, which are arranged in a bundle and are surrounded by a tube 30, which is produced from the aforementioned resin systems. A number of such micromodules 100 are arranged in a cable core 200 of the optical cable. Extruded around the cable core 200 is an outer jacket 300, for example of a plastic such as polyethylene. The micromodules 100 may be movably arranged within the cable core 200 or be surrounded by a filling composition 210. The micromodules 100 may also be movably arranged within the filling composition 210.

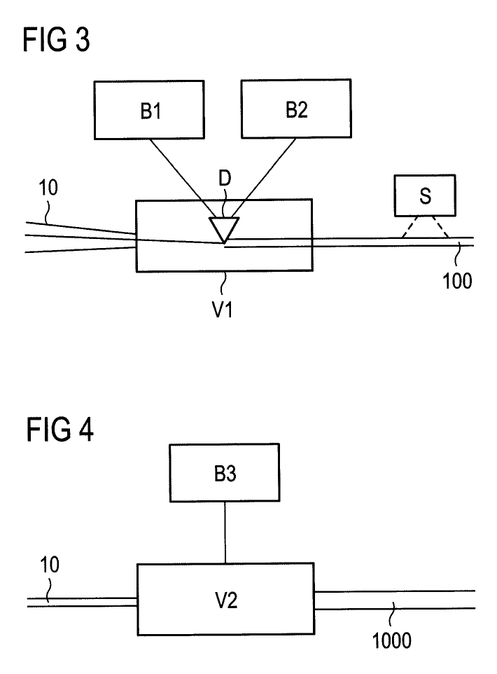

FIG. 3 shows an exemplary production line for producing an optical transmission element 100 of the optical cable 1000. In this case, a number of optical waveguides 10 are fed to a processing unit V1. Connected to the processing unit V1 are a container B1 and a container B2. In the container B1 is the filling composition 21. In the processing unit V1, the optical waveguides are surrounded by the heated filling composition 21. Mixtures of mineral or paraffin oils, rubber and/or aerosils are used here, for example, as filling compositions.

Furthermore, in the processing unit V1, the tube 30 is extruded around the filling composition 21 from a material comprising a resin. For this purpose, the processing unit V1 is connected to a container B2, which contains the material comprising the resin (resin system). The resin system substantially comprises an acrylate, which may be mixed with a filler. Inorganic materials are added to the acrylate, for example, as the filler. Fillers of chalk or magnesium hydroxide are used here, for example. Furthermore, glass fibers may also be admixed with the resin system in the processing unit V1. The acrylic resins applied as the tube in the processing unit V1 contain, for example, molecules of methacrylic acid. These comprise monomers and oligomers. The mechanical properties of the acrylic resin, in particular the hardness, elongation at break and deformability, of the tube 30 can be adjusted in the processing unit V1 by means of the proportion of oligomers used. The more oligomers are contained in the acrylic resin, the harder the tube 30.

The tube 30 and the filling composition 21 are applied, for example, in one operation. The application of the filling composition 21 to the optical waveguides 10 and the surrounding of the filling composition 21 with the micromodule tube 30 takes place, for example, by double-layer wetting. The filling composition 21 and the resin systems of the micromodule tube 30 are applied here, for example, through an annular die D. In the processing in the processing unit V1, the material comprising the resin of container B2 is an aqueous solution, which is applied by jetting processes at room temperature.

The use of resin systems that are applied as an aqueous solution allows very high processing speeds to be achieved. The processing speeds in this case lie the range between 500 and 700 m/min. This corresponds to 3 to 4 times the speeds that were possible in the extrusion of polymer materials previously used as the micromodule tube. Furthermore, the buffering layer 30, which is applied as an aqueous solution by a wetting operation, can be of a particularly thin form. With the use of the acrylic resin systems as materials for the buffering layer 30, a layer thickness of the buffering layer in the range from 0.05 to 0.5 mm can be achieved as a result.

After the wetting of the optical waveguides with the filling composition 21 and the resin systems of the tube 30, the aqueous layer of the tube 30 is irradiated with light, for example ultraviolet light. Preferably contained in the material comprising the resin are photoinitiators, which form a network structure when they are irradiated with ultraviolet light within the resin material. When these UV resin systems are completely crosslinked, a thermoset or elastomeric state which cannot be broken down even under great heat exposure is produced. This makes it possible to use the optical transmission elements even in high-temperature environments. The previously used polymer materials, which were generally formed as low-melting thermoplastics, are already molten at 70° C. to 80° C. By contrast, the UV-crosslinkable resin systems used for the tube 30 have a higher thermal stability. The viscosities of the filling material 21 and of the acrylic resins preferably lie between 4000 and 8000 MPas. The use of resin systems for the tube 30 also has the advantage that the material can be pulled or peeled off without any great force being exerted. As a result, easy accessibility to the optical waveguides is made possible.

The micromodules 100 that leave the processing unit V1 are wound up onto a drum after irradiation with UV light and the curing process. To produce a cable 1000 as shown in FIG. 4, a number of the micromodules 100 wound up on a drum are fed to a processing unit V2. In the processing unit V2, an outer jacket 300, for example a cable jacket of polyethylene, is extruded around the micromodules. The space enclosed by the cable jacket 300 may in this case be formed without any filling composition or contain a filling composition in which the micromodules 100 are embedded.

What is claimed is:

1. An optical cable, comprising:
a plurality of optical transmission elements, each optical transmission element comprising:
a plurality of optical waveguides, each of which contains a glass optical fiber; and
a tube surrounding a space in which the optical waveguides are contained, wherein each tube comprises a resin; and
a jacket surrounding a space in which the optical transmission elements are contained.

2. The optical cable of claim 1, the resin comprising an acrylate.

3. The optical cable of claim 2, each tube further comprising one or more fillers mixed into the resin.

4. The optical cable of claim 3, the fillers comprising one or more inorganic materials.

5. The optical cable of claim 4, the inorganic materials comprising glass fiber offcuts.

6 . The optical cable of claim 5, the inorganic materials comprising chalk.

7 . The optical cable of claim 5, the inorganic materials comprising magnesium hydroxide.

8. The optical cable of claim 4, the inorganic materials comprising magnesium hydroxide.

9. The optical cable of claim 8, wherein the resin comprises photoinitiators and the resin has a network structure formed by UV irradiation.

10. The optical cable of claim 4, the inorganic materials comprising chalk.

11. The optical cable of claim 2, wherein the acrylate comprises molecules of methacrylic acid.

12. The optical cable of claim 1, wherein each optical waveguide is movably arranged in its respective tube and wherein the space within the jacket contains a filling composition.

13. The optical cable of claim 12, wherein the filling composition comprises at least one of: mineral oils, paraffin oils, rubber, and aerosil.

14. The optical cable of claim 1, wherein each optical waveguide comprises a cladding surrounding its glass optical fiber.

15. The optical cable of claim 14, wherein the cladding is formed from the same material as the resin.

16. The optical cable of claim 1, wherein each optical transmission element is movably arranged within the cable jacket.

17. The optical cable of claim 16, wherein the space within the cable jacket contains a filling composition.

18. The optical cable of claim 17, wherein the resin comprises photoinitiators and the tubes have a network structure formed by UV irradiation.

19. The optical cable of claim 1, wherein the resin comprises molecules of methacrylic acid.

20. An optical cable, comprising:
a plurality of optical transmission elements, each optical transmission element comprising:
a plurality of optical waveguides, each of which contains a glass optical fiber and a cladding surrounding the glass optical fiber;
a tube surrounding a space in which the optical waveguides are contained, wherein each tube comprises a resin and at least one filler mixed in the resin, the resin comprising an acrylate and a photoinitiator so that the tube has a network structure formed by UV irradiation, and wherein each optical waveguide is movably arranged in the tube; and
a filling composition in the space within the tube;
a jacket surrounding a space in which the optical transmission elements are contained, wherein each optical transmission element is movably arranged in the jacket; and
a filling composition within and contacting the jacket.

21. A method for producing an optical cable, comprising:
producing a plurality of optical transmission elements by:
providing at least one optical waveguide containing a glass optical fiber; and
forming a tube around a space in which the at least one optical waveguide is contained, the tube comprising a resin; and
surrounding the at least one optical transmission element with a cable jacket, wherein,
optical cable is produced at a line speed of at least 500 meters per minute.

22. The method of claim 21, wherein the resin comprises:
an acrylate containing molecules of methacrylic acid; and
at least one of inorganic fillers of: glass fiber offcuts, chalk, and magnesium hydroxide.

23. The method of claim 22, further comprising surrounding the at least one optical waveguide with a filling composition.

24. The method of claim 22, further comprising wetting the at least one optical waveguide with filling composition and at the same time wetting the filling composition with the material comprising the resin.

25. The method of claim 21, further comprising wetting the at least one optical waveguide filling composition and at the same time wetting the filling composition with the material comprising the resin.

26. The method of claim 21, wherein surrounding the at least one optical transmission element with a cable jacket comprises curing the resin.
